(19) United States
(12) Patent Application Publication
(10) Pub. No.: US 2023/0152462 A1
(43) Pub. Date: May 18, 2023

(54) LIDAR SENSOR, IN PARTICULAR A VERTICAL FLASH LIDAR SENSOR

(71) Applicant: Robert Bosch GmbH, Stuttgart (DE)

(72) Inventors: Johannes Richter, Ludwigsburg (DE); Karl Christoph Goedel, Vaihingen An Der Enz (DE)

(21) Appl. No.: 17/917,321

(22) PCT Filed: Jun. 17, 2021
(86) PCT No.: PCT/EP2021/066450

§ 371 Date: Oct. 6, 2022

(30) Foreign Application Priority Data
Jun. 30, 2020 (DE) 10 2020 208 104.2

(51) Int. Cl. G01S 17/894; G01S 7/4914; G01S 17/42

(52) U.S. Cl. CPC G01S 17/894; G01S 7/4914; G01S 17/42

(57) ABSTRACT

A LiDAR sensor, in particular a vertical flash LiDAR sensor. The LiDAR device has a laser source, which is designed to emit a laser signal into a transmission path, and a pixel detector, which has at least one macropixel array, which is designed to detect a reflected laser signal in a receiving path. The pixel detector here is designed to evaluate at least two macropixel arrays at each of its measuring points.

### FIELD

The present invention relates to a LiDAR sensor, in particular a vertical flash LiDAR sensor, comprising a laser source, which is designed to emit a laser signal in a transmission path, and comprising a pixel detector, which comprises at least one macropixel array, which is designed to detect a reflected laser signal in a receiving path.

### BACKGROUND INFORMATION

Highly automated or fully automated driving with motor vehicles (Level 3-5) in road traffic will become more and more common in the coming years. This automation of driving motor vehicles is achieved with a variety of concepts. Common to all these concepts is that they require sensors to sense the surroundings of the autonomously driving motor vehicle. Different sensors can be used for this purpose, for example video cameras, radar sensors or ultrasonic sensors. One particular type of sensor is playing an increasingly important role. The sensors being discussed are LiDAR sensors. These are optical sensors that use a laser source to emit a laser signal into a receiving path. The emitted laser signal is reflected on the objects in the surroundings of the LiDAR sensor and back into the LiDAR sensor. There, the reflected laser signal is typically detected in a pixel detector. This creates a 3D point cloud of the surroundings. The LiDAR sensor can be configured as a vertical flash macroscanner. This type of LiDAR sensor creates a horizontal deflection of the emitted laser signal by means of a rotating scanner (for example a rotating mirror or a rotating transmitter and receiver module) and a vertical deflection by emitting a vertically divergent laser signal. This vertically emitted laser signal is mapped onto the pixel detector in the receiving path. This pixel detector can comprise at least one micropixel array. The micropixel array can be implemented by means of a plurality of diodes, for example. These micropixel arrays are typically aggregated and evaluated together to improve the statistics. In that case then, it is referred to as a macropixel array. The pixel detector can therefore comprise at least one macropixel array. Improving the statistics by aggregating micropixels is useful in particular when using binary pixel detectors, such as single-photon avalanche diodes (SPAD).

### SUMMARY

According to the present invention, a LiDAR sensor is provided in which the pixel detector is designed to evaluate at least two macropixel arrays at each of its measuring points.

For a LiDAR sensor, there are often two requirements for mapping the surroundings. On the one hand, the LiDAR sensor should have a long range. This allows objects at long distances from the LiDAR sensor to be detected early. On the other hand, it is important to determine the location and size of the objects present in the immediate vicinity of the LiDAR sensor as accurately as possible. This requires the highest possible angular resolution of the LiDAR sensor. These two requirements for the LiDAR sensor typically run counter to one another, however, which makes it necessary to find a compromise between them. According to an example embodiment of the present invention, it is now provided that at least two macropixel arrays be evaluated in each measuring point of the pixel detector. The requirements for the long range of the LiDAR sensor and the high angular resolution of the LiDAR sensor can thus be distributed across at least two different macropixel arrays. The two conflicting requirements can be satisfied at the same time. Both a long range and a high angular resolution can be achieved. This does not require any additional hardware in the LiDAR sensor, just an appropriate configuration of the macropixel arrays. Such a LiDAR sensor can be provided at a correspondingly low cost.

According to an example embodiment of the present invention, it is also possible for the at least two evaluated macropixel arrays to have different widths.

The different widths of the two evaluated macropixel arrays provide two macropixel arrays having different configurations. A “narrow” macropixel array can be provided. This narrow macropixel array enables a high angular resolution of the LiDAR sensor. The intensity of the reflected laser signal is distributed homogeneously within the macropixel. An accurate determination of the location and size of objects in the vicinity of the LiDAR sensor becomes possible. A “wide” macropixel array will be provided as well. This wide macropixel array enables a maximization of the range for low-reflective objects. Early detection of objects at long distances from the LiDAR sensor is possible. This different configuration of the at least two evaluated macropixel arrays can also lead to an increase in the dynamic range for signal intensities of the LiDAR sensor. Highly reflective objects can drive the narrow macropixel array into saturation, for example, because the intensity of the reflected laser signal is too high. A correct intensity measurement is consequently no longer possible. However, if the same measuring point is now also evaluated via the broad macropixel array, the intensity of the laser signal can sometimes still be resolved.

In one particular example embodiment of the present invention, a first evaluated macropixel array has a width which is matched to a width of the reflected laser signal.

The first evaluated macropixel array is the narrow macropixel array. The scanning step of the LiDAR sensor can thus correspond exactly to the width of the narrow macropixel array. For a vertical flash LiDAR sensor, this can be the horizontal width of the laser signal, for example. The narrow macropixel array then enables a higher horizontal resolution. The angular resolution is increased. The location and size of objects can be precisely determined.

It is also advantageous that the first evaluated macropixel array is designed to detect the reflected laser signal in a plateau of the reflected laser signal.

In addition to the higher horizontal resolution in a vertical flash LiDAR sensor, this also achieves a homogeneous distribution of the intensity of the laser signal over the width of the first evaluated macropixel array. Objects can thus be detected with the same intensity everywhere in the first evaluated macropixel array.

According to an example embodiment of the present invention, it is then advantageous that a second evaluated macropixel array has a width that is greater than the width of the first evaluated macropixel array.

The second evaluated macropixel array corresponds to the wide macropixel array. In addition to the detection of the laser signal in a plateau of the laser signal, the flanks of the intensity of the laser signal which fall laterally from the plateau of the laser signal are measured here as well. It is no longer possible to achieve a homogeneous distribution of the intensity of the laser signal. However, the sensitivity of the second evaluated macropixel array is increased. The homogeneous distribution is nonetheless ensured by the simultaneous evaluation of the first macropixel array.

It can advantageously be provided that the width of the second evaluated macropixel array covers at least 85% of the width of the reflected laser signal.

This makes it possible to optimize the signal-to-noise ratio of the second evaluated macropixel array. Thus, at least 85% of the width of the laser signal is covered. The best possible signal-to-noise ratio is established. The sensitivity of the LiDAR sensor is increased. A long range of the LiDAR sensor is obtained.

According to an example embodiment of the present invention, it is advantageous that the measurement data of the at least two evaluated macropixel arrays is output in parallel in a point cloud or the measurement data of one of the at least two evaluated macropixel arrays is output according to predefined conditions.

The best signal for the evaluation for each reflected laser signal can be selected depending on the situation. The predefined conditions for outputting the measurement data of one of the at least two macropixel arrays can be specified by means of an algorithm.

Advantageous further developments of the present invention are disclosed herein.

### BRIEF DESCRIPTION OF THE DRAWINGS

Example embodiments of the present invention will be explained in more detail with reference to the figures and the following description.

FIG. 1A shows a diagram of the intensity of a laser signal as a function of the width of a macropixel array.

FIG. 1B shows a diagram of the signal-to-noise ratio as a function of the width of the macropixel array.

FIG. 2 shows an illustration of a first evaluated macropixel array and a second evaluated macropixel array, as well as a cross-section through an associated profile of a laser signal.

### DETAILED DESCRIPTION OF EXAMPLE EMBODIMENTS

The present invention relates to a LiDAR sensor, in particular a vertical flash LiDAR sensor, comprising a laser source, which is designed to emit a laser signal in a transmission path, and comprising a pixel detector, which comprises at least one macropixel array 1, 2, which is designed to detect a reflected laser signal in a receiving path, wherein the pixel detector is designed to evaluate at least two macropixel arrays 1, 2 at each of its measuring points. The at least two macropixel arrays 1, 2 can be provided by a first evaluated macropixel array 1 and a second evaluated macropixel array 2. The second evaluated macropixel array 2 has a width 3 that is greater than a width 4 of the first evaluated macropixel array 1.

The detection of the reflected laser signal can include the determination of the intensity 5 of the laser signal. A signal-to-noise ratio 6 of the reflected laser signal can be acquired as well.

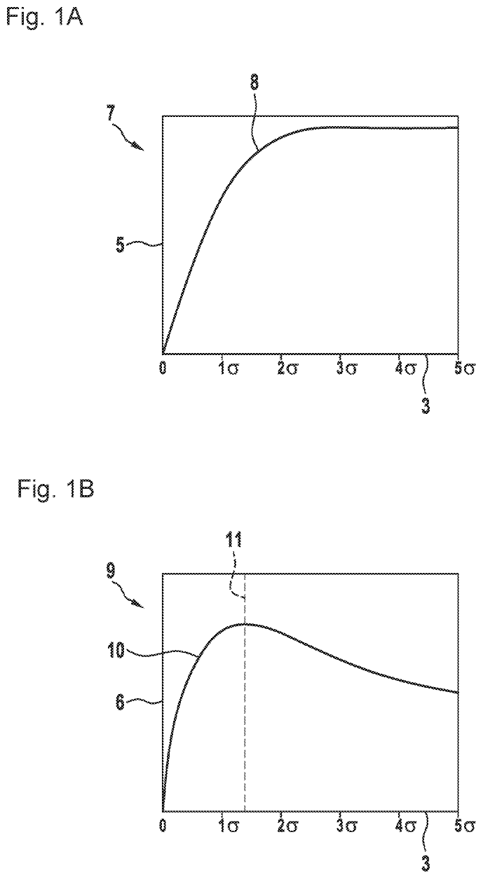

FIG. 1A therefore shows a diagram 7, which shows a function 8 of the intensity 5 of the laser signal as a function of the width 3 of the second evaluated macropixel array 2. The width 3 of the second evaluated macropixel array 2 is stated in units of a width σ of the laser signal. This is based on the following assumption, for example. The laser signal is assumed to have the shape of a “Gaussian bell.” This Gaussian bell has the width σ. It is furthermore assumed that the noise of the background light follows and is dominated by a Poisson distribution.

FIG. 1B accordingly shows a diagram 9, which indicates a function 10 of the signal-to-noise ratio 6 as a function of the width 3 of the second evaluated macropixel array 2. The width 3 is again stated in units of the width σ of the laser signal. It can be seen that there is a line 11 that intersects the maximum of the signal-to-noise ratio 6. This line 11 lies at a width 3 of the second evaluated macropixel array 2, which corresponds to approximately 1.4 times the width σ of the laser signal. At this maximum, 85% of the laser signal is already covered.

In other words, the optimum signal-to-noise ratio 6 can be achieved by selecting the width 3 of the second evaluated macropixel array 2 such that 85% of the laser signal is covered. It should be noted, however, that at this point there is no longer a homogeneous intensity 5 of the laser signal within the second evaluated macropixel array 2, because the Gaussian bell has already fallen off too sharply. A high sensitivity for the second evaluated macropixel array 2 can nonetheless be achieved thanks to the optimum signal-to-noise ratio 6. The second evaluated macropixel array 2 can achieve a long range for the LiDAR sensor, which ensures early detection of objects at long distances.

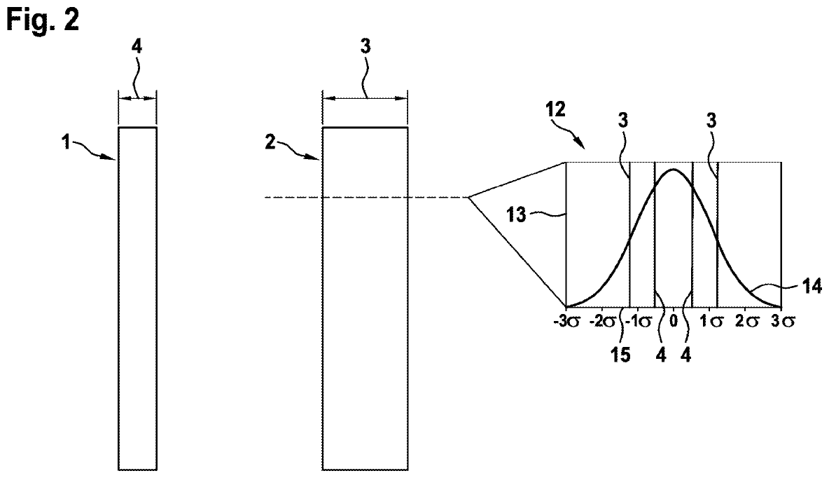

FIG. 2 now shows the first evaluated macropixel array 1 next to the second evaluated macropixel array 2. It can be seen that the width 3 of the second evaluated macropixel array 2 is greater than the width 4 of the first evaluated macropixel array 1. A diagram 12 additionally shows the laser profile 13 as a function 14 of the position 15 on the macropixel array 1, 2. The position 15 is shown in units of the width σ of the laser signal. The widths 3, 4 of the first evaluated macropixel array 1 and the second evaluated macropixel array 2 are shown as well.

The width 3 of the second evaluated macropixel array 2 was selected to be 1.4 times the width σ of the laser signal, as described above. This again makes it possible for 85% of the laser signal to be covered by the second macropixel array 2. The result is an optimum signal-to-noise ratio 6. The sensitivity and range of the LiDAR sensor are increased. Early detection of objects at long distances is possible. The width 4 of the first evaluated macropixel array 1, on the other hand, is selected such that it includes the plateau or the maximum of the function 14 as can be seen here. At the same time, this also makes it possible to achieve a homogeneous distribution of the intensity 5. The objects to be detected are detected with the same intensity everywhere on the first evaluated macropixel array 1. This results in a high angular resolution of the first evaluated macropixel array 1. An accurate determination of the location and size of objects becomes possible.

Overall, therefore, a LiDAR sensor having a long range and a high angular resolution can be provided.

Although the present invention has been illustrated and described in more detail using preferred design examples, the present invention is not limited by the disclosed examples and other variations can be derived from this by a person skilled in the art without departing from the scope of protection of the present invention.

1-7. (canceled)

8. A LiDAR sensor, comprising:
a laser source configured to emit a laser signal in a transmission path; and
a pixel detector including at least two macropixel arrays, which is configured to detect a reflected laser signal in a receiving path, the pixel detector being configured to evaluate the at least two macropixel arrays at each of its measuring points.

9. The LiDAR sensor as recited in claim 8, wherein the LiDAR sensor is a vertical flash LiDAR sensor.

10. The LiDAR sensor according to claim 8, wherein the at least two evaluated macropixel arrays have different widths.

11. The LiDAR sensor according to claim 10, wherein a first evaluated macropixel array of the at least two evaluated micropixel arrays has a width which is matched to a width (f the reflected laser signal.

12. The LiDAR sensor according to claim 11, wherein the first evaluated macropixel array is configured to detect the reflected laser signal in a plateau of the reflected laser signal.

13. The LiDAR sensor according to claim 11, wherein a second evaluated macropixel array of the at least two evaluated micropixel arrays has a width that is greater than the width of the first evaluated macropixel array.

14. The LiDAR sensor according to claim 13, wherein the width of the second evaluated macropixel array covers at least 85% of the width of the reflected laser signal.

15. The LiDAR sensor according to claim 8, wherein: (i) measurement data of the at least two evaluated macropixel arrays is output in parallel in a point cloud, or (ii) measurement data of one of the at least two evaluated macropixel arrays is output according to predefined conditions.
